(19) United States
(12) Patent Application Publication
(10) Pub. No.: US 2005/0103137 A1
(43) Pub. Date: May 19, 2005

(54) Screw nut assembly of linear actuation device

(76) Inventors: Chih-Hsien Chang, Sindian City (TW); Chih Hsien Chen, Sindian City (TW)

Correspondence Address: HDSL, 4331 STEVENS BATTLE LANE, FAIRFAX, VA, 22033, US

(21) Appl. No.: 10/706,946

(22) Filed: Nov. 14, 2003

(51) Int. Cl. F16H 1/20

(52) U.S. Cl. 74/89.26; 74/89.35

(57) ABSTRACT

A screw nut assembly of a linear actuation device, having a screw, a main screw nut and a safety screw nut is disclosed. The main screw nut and the safety screw nut engaged with the screw are operative to displace linearly along an axis of the screw. The safety screw nut includes an exterior surface and the main screw nut includes a receiving portion for receiving the safety screw nut. The exterior surface of the safety screw nut and an interior surface of the receiving portion of the main screw nut further include a notch and a resilient member to be engaged with the notch.

### BACKGROUND OF THE INVENTION

The present invention relates to a screw nut assembly of a linear actuation device, and more particular, to a screw nut assembly of which the main screw nut can be ejected by spring force when the threads thereof are worn out.

Linear actuation device uses motors, gears and lever linkage for driving a guide screw, so as to provide linear extension and retraction movements of an interior tube. Such device has been commonly applied to elevate or lower a sickbed or other devices.

The screw of the typical linear actuation device uses a screw nut threaded with the screw to perform movements of the interior tube. To reduce the noise caused by friction between the screw nut and the screw, plastic material has been used to fabricate the screw nut. However, as the screw is typically fabricated from metal, the threads formed on the screw nut are easily abraded. Therefore, the screw nut becomes inoperative to carry the load, such that the linear actuation device cannot operate normally. Further, the interior will suddenly sink without the support of the screw nut.

### BRIEF SUMMARY OF THE INVENTION

The present invention provides a screw nut assembly of a linear actuation device. The screw nut assembly includes a main screw nut and a safety screw engaged with each other by spring force. When the threads of the main screw are worn out, the main screw nut is ejected by spring force, and the safety screw nut replaces the main screw nut to carry the load applied on the main screw. Therefore, the damage of the linear actuation device is prevented.

The screw nut assembly of a linear actuation device provided by the present invention comprises a screw, a main screw nut and a safety screw nut. The main screw nut and the safety screw nut engaged with the screw are operative to displace linearly along an axis of the screw. The exterior surface of the safety screw nut and an interior surface of the receiving portion of the main screw nut further include a notch and a resilient member to be engaged with the notch.

### BRIEF DESCRIPTION OF THE DRAWINGS

These, as well as other features of the present invention, will become apparent upon reference to the drawings wherein:

FIGS. 1 shows a cross sectional view of a screw nut assembly applied to a linear actuation device;

FIG. 2 shows enlarged views of the main screw nut and the safety screw nut of the screw nut assembly;

FIG. 3 shows an exploded view of the screw nut assembly;

FIG. 4 shows a perspective view of the screw nut assembly;

FIG. 5 shows a cross sectional view of the screw nut assembly;

FIG. 6 shows an exploded view of a screw nut assembly in a second embodiment;

FIG. 7 shows a perspective view of the screw nut assembly; in the second embodiment; and

FIG. 8 shows a cross-sectional view of the screw nut assembly in the second embodiment.

### DETAILED DESCRIPTION OF THE INVENTION

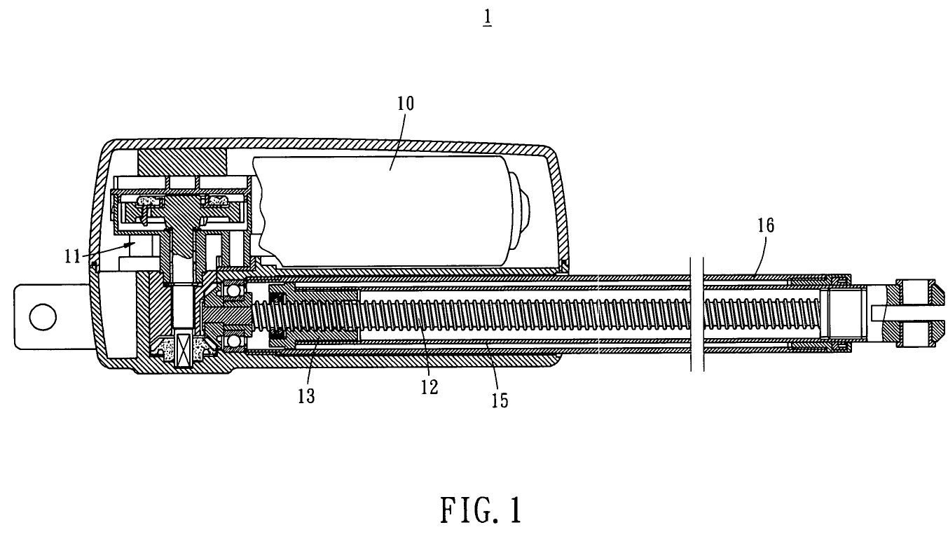

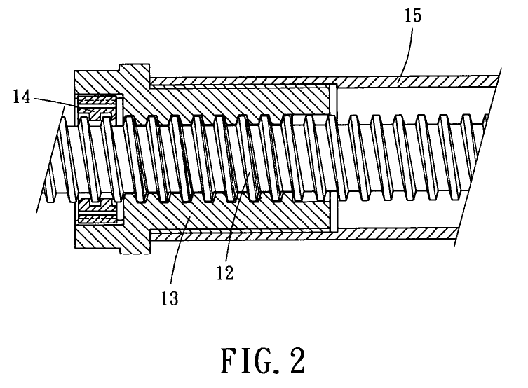

As shown in FIG. 1, a linear actuation device 1 includes a motor 10 to actuate a driving assembly 11 which includes gears and linking levers, which then drives a screw 12 to rotate. Under normal operation conditions, the threads of the screw 12 are engaged with a main screw nut 13 and a safety screw nut 14 (as shown in FIG. 2), which synchronously drive the screw 12 to perform axial linear displacement, so as to drive the interior tube 15 connected to the main screw nut 13. The movement of the interior tube 15 then actuates the extension or retraction of the exterior tube 16 of the actuation device 1.

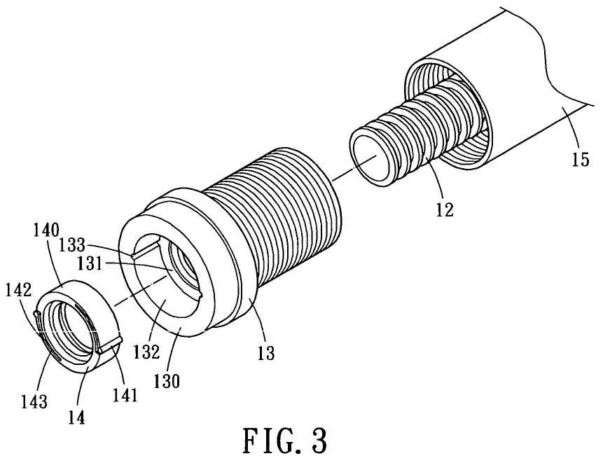

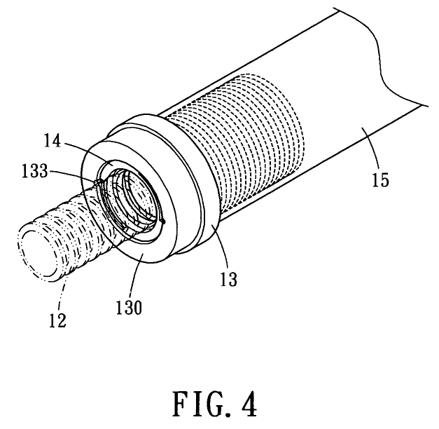

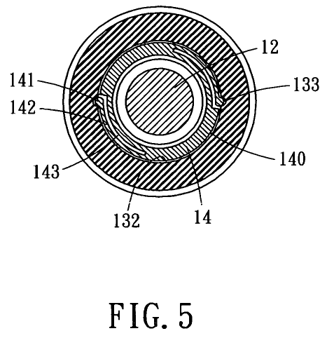

As shown in FIGS. 3-5, an exploded view, a perspective view and a cross-sectional view of a first embodiment of a screw nut assembly for the actuation device are illustrated. The screw nut assembly includes a main screw nut 13 and a safety screw nut 14 to be engaged with the screw 12. The main screw nut 13 is preferably fabricated from plastic material to reduce noise caused by friction between the screw 12 and the main screw nut 13 when a relative linear displacement is performed. The safety screw nut 14 is preferably fabricated from metal. As a consequence, when the threads of the main screw nut 13 are worn out, the safety screw nut 14 will replace the main screw nut 13 to carry the load of the screw 12.

In this embodiment, the main screw nut 13 includes one threaded distal end, and one proximal end serving as a receiving part 131 for receiving the safety screw nut 14 therein. Preferably, the receiving part 131 has a flange 130 and an interior sidewall 132. The receiving part 131 further comprises two opposing grooves 133 recessed from the interior sidewall 132. An exterior surface 140 of the safety screw nut 14 includes a pair of curved arms 142 each ended with a resilient terminals 141 opposing to each other. The curved arms 142 extend along the exterior surface 140 and are spaced from the exterior surface 140 by a gap 143. When the safety screw nut 14 is inserted into the receiving part 131, the resilient terminals 141 are aligned with the grooves 133, and the arms 142 are pressed against the exterior surface 140 to fit in the receiving part 131. Thereby, the safety screw nut 14 is engaged within the main screw nut 14 by spring force exerted from the arms 142.

When the threads of the main screw nut 13 are worn out, as the screw 12 is still engaged with the safety screw nut 14, the screw 12 can still be supported by the safety screw nut 14 and returns to the original positions by the momentum. However, when the threads of the main screw nut 13 are worn out because of friction or abrasion, the main screw nut 13 is ejected from the screw nut assembly by spring force exerted by the resilient terminals 141. Meanwhile, as the safety screw nut 14 provides much fewer threads to engage with the screw 12, the available torque provided by the safety screw nut 14 is insufficient to actuate full retraction or extension movement of the screw 12. Therefore, a free spin occurs, and the user can easily observe damage of the main screw nut 13.

Thereby, a screw nut assembly for an actuation device is obtained.

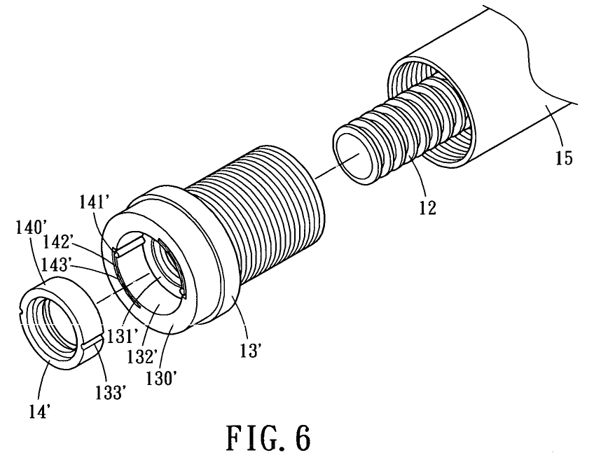

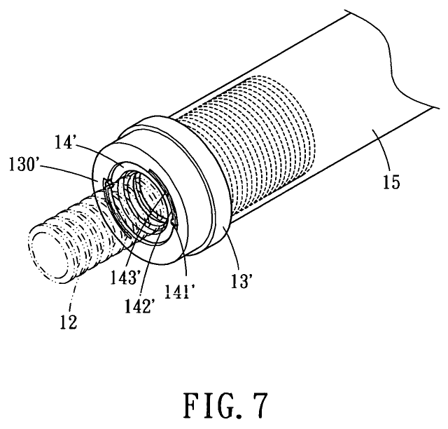

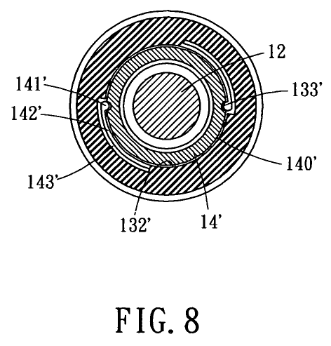

As shown in FIGS. 6-8, an exploded view, a perspective view and a cross sectional view of a second embodiment of screw nut assembly are depicted. In this embodiment, the main screw nut 13′ still includes the flange 130′ and the receiving part 131′ for receiving the safety screw nut 14′. However, two opposing grooves 133′ are formed on the exterior surface 140′ of the safety screw nut 14′, while two opposing curved arms 142′ extend from two opposing points of the interior sidewall 132′ and terminate with two opposing resilient terminals 141′. The safety screw nut 1′4 is thus able to engage with the main screw nut 13′ in a way similar to the first embodiment.

This disclosure provides exemplary embodiments of the present invention. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

1. A screw nut assembly for an actuation device which comprises a screw, comprising a main screw nut and a safety screw nut engaged with the screw, for synchronously driving the screw to perform axial linear displacement,
wherein the safety screw nut includes an exterior surface and the main screw nut includes a receiving portion for receiving the safety screw nut, the exterior surface of the safety screw nut and an interior surface of the receiving portion of the main screw nut further comprise a notch and a resilient member to be engaged with the notch.

2. The assembly of claim 1, wherein the main screw nut is fabricated from plastic material and the safety screw nut is fabricated from metal.

3. The assembly of claim 1, wherein the notch is formed on the interior surface of the receiving portion and the resilient member is mounted to the exterior surface of the safety screw nut.

4. The assembly of claim 3, wherein the resilient member includes a resilient arm having one end extending from the exterior surface of the safety screw nut and an elongate arm extending along the exterior surface and spaced from the exterior surface by a gap.

5. The assembly according to claim 1, wherein the notch is formed on the exterior surface of the safety screw nut and the resilient member is mounted to the interior surface of the receiving portion.

6. The assembly according to claim 5, wherein the resilient member includes a resilient arm having one end extending from the interior surface of the receiving portion and an elongate arm extending along the interior surface and spaced from the interior surface by a gap.
